(19) United States
(12) Patent Application Publication
(10) Pub. No.: US 2019/0099743 A1
(43) Pub. Date: Apr. 4, 2019

(54) Catalyst Composition Including a Biochar, and Related Methods

(71) Applicant: Board of Supervisors of Louisiana State University and Agricultural and Mechanical College, Baton Rouge, LA (US)

(72) Inventors: Jim Jian Wang, Baton Rouge, LA (US); Jonghwan Park, Sacheon-si (KR)

(21) Appl. No.: 16/150,400

(22) Filed: Oct. 3, 2018

Related U.S. Application Data
(60) Provisional application No. 62/567,845, filed on Oct. 4, 2017.

(51) Int. Cl. B01J 23/745; C02F 1/72; B01J 27/20; B01J 35/10; B01J 37/02; B01J 37/08

(52) U.S. Cl. CPC B01J 23/745; C02F 1/725; B01J 27/20; B01J 35/1038; C02F 2101/308; B01J 37/0209; B01J 37/084; C02F 2305/026; B01J 35/1019

(57) ABSTRACT

Compositions for treating a waste source, and related methods are described herein. The composition includes a biochar impregnated with iron. The composition is produced by impregnating a biomass with a pretreatment solution comprising an iron containing compound to form a pretreated biomass, dehydrating the pretreated biomass, and pyrolyzing the pretreated biomass under conditions sufficient to form a biochar. A related method includes contacting a waste source including a pollutant with the composition and hydrogen peroxide to form a reaction mixture, oxidizing at least a portion of the pollutant under conditions sufficient to form an oxidized pollutant or intermediate compound, and separating the oxidized pollutant or intermediate compound from the reaction mixture.

### CROSS-REFERENCE TO RELATED APPLICATIONS

This application claims the benefit of U.S. Provisional Application No. 62/567,845, filed Oct. 4, 2017. The patent application identified above is incorporated here by reference in its entirety.

### TECHNICAL FIELD

The present disclosure relates to compositions for treating a waste source, and related methods. More specifically, the present disclosure relates to a catalyst composition including a biochar for treating a waste source, and related methods.

### BACKGROUND

This section introduces information from the art that may be related to or provide context for some aspects of the techniques described herein and/or claimed below. This information is background facilitating a better understanding of that which is disclosed herein. Such background may include a discussion of “related” art. That such art is related in no way implies that it is also “prior” art. The related art may or may not be prior art. The discussion is to be read in this light, and not as admissions of prior art.

Water pollution by recalcitrant pollutants (e.g., organic dyes, pesticides, phenol compounds, antibiotics, landfill leachates from industrial effluents, and so forth) has increasingly become a worldwide problem. Many recalcitrant pollutants have been found to have toxic effects on organisms and accumulate in biota. For example, many recalcitrant pollutants have low ratio of BOD/COD, and therefore are not easily decomposed by microorganisms in conventional biological treatment processes or natural environments.

Advanced oxidation processes (AOP) have been developed and proposed for the degradation of recalcitrant pollutants as a pre-treatment of biological processes. For example, a Fenton reaction with Fe²⁺ and H₂O₂ can be an efficient and cost-effective AOPs for the removal of pollutants in wastewater including recalcitrant organic pollutants. Fenton's reagent as oxidation system, which is based on the reaction of H₂O₂ with Fe²⁺/Fe³⁺ ions, has been used as a good source of oxidative radicals. The generation of hydroxyl radicals can occur by the reaction of H₂O₂ with Fe²⁺ (Eq. 1), and Fe³⁺ reacts with H₂O₂ leading to the regeneration of Fe²⁺, extending the Fenton process (Eq. 2 and 3):

Fe²⁺+H₂O₂ [symbol] Fe³⁺+OH⁻+OH. (Eq. 1)

Fe³⁺+H₂O₂⇔Fe(OOH)²⁺+H⁺ (Eq. 2)

Fe(OOH)²⁺ [symbol] Fe²⁺+OH₂. (Eq. 3)

However, such conventional homogeneous Fenton reactions can have disadvantages. For example, conventional homogenous Fenton reactions generally require stoichiometric amounts of Fenton reagents with H₂O₂ and Fe²⁺ at an optimum pH in the range of from 2.5 to 3.0. Additionally, the dissolved iron salts generally cannot be recycled, and thus a large amount of iron oxide sludge is generated, which requires additional treatments. Separation of iron salts and sludge from the treated water also can require more effort, and the process can be limited by issues with disposing the sludge.

To overcome the disadvantages of the conventional homogeneous Fenton reactions, heterogeneous Fenton reactions employing iron-impregnated solid supports as catalysts have been developed in recent years. Such heterogeneous Fenton reactions might offer some advantages over the homogeneous reaction, such as no sludge formation and the possibility to recycle the iron catalyst. However, its applications for wastewater treatment have been limited because most heterogeneous Fenton reaction catalysts tend to exhibit low efficiency and stability.

Carbon-based catalysts such as activated carbon, carbon nanotubes, and graphene have attracted attention because of their characteristics including acid/base resistance and high thermal stability. The carbon-based catalysts exhibit high specific surface area, which can improve the activity of iron oxide by preventing agglomeration of the catalyst and improving its dispersibility. One such example is a magnetic carbon catalyst containing iron introduced through an impregnation method of activated carbon, which can be manipulated by a device providing a magnetic field. However, to produce such iron impregnated activated carbon catalysts, two thermal decomposition steps are typically required, which increases the cost of catalyst preparation. In addition, the complexity of the iron impregnated activated carbon catalyst manufacturing process makes the process costly to manufacture and use. Therefore, there remains a need for improved catalyst compositions for a heterogeneous Fenton reaction, and methods for the production and use of such catalysts.

Contained herein is a disclosure directed to resolving, or at least reducing, one or more of the problems mentioned above, or other problems that may exist in the art.

### NON-LIMITING BRIEF SUMMARY

The present disclosure relates to compositions for treating a waste source, and related methods.

In an aspect, the present disclosure provides a catalyst composition comprising a biochar including iron present in an amount in the range of about 0.10 wt. % to about 30 wt. %, based on total weight of the biochar; and wherein the biochar has a pH in the range of from about 2 to about 7.

One or more aspects of the present disclosure include the catalyst composition of the preceding paragraph wherein the iron is impregnated in the biochar in the form selected from the group consisting of Fe₃O₄, Fe₂O₃, FeOOH, and any combination of two or more of the foregoing.

One or more aspects of the present disclosure include the catalyst composition of any preceding paragraph wherein the biochar further comprises a component selected from the group consisting of sulfur, chlorine, nitrogen, and any combination of two or more of the foregoing, wherein the component is present in an amount in the range of 0.02 wt. % to about 10 wt. %, based on total weight of the biochar.

One or more aspects of the present disclosure include the catalyst composition wherein the biochar has a surface area in the range of about 170 to about 230 m²/g.

One or more aspects of the present disclosure include the catalyst composition of any preceding paragraph wherein the biochar has a total pore volume in the range of about 0.1 to about 0.2 cm³/g.

One or more aspects of the present disclosure include the catalyst composition of any preceding paragraph wherein biochar has an ash content present in an amount in the range of about 10 wt. % to about 50 wt. %, based on total weight of the biochar.

One or more aspects of the present disclosure include the catalyst composition of any preceding paragraph wherein the biochar has an iron content from about 8 wt. % to about 20 wt. %, based on total weight of the biochar.

In another aspect, the present disclosure provides a method for forming a biochar. The method includes impregnating a biomass with a pretreatment solution comprising an iron containing compound to form a pretreated biomass, dehydrating the pretreated biomass, and pyrolyzing the pretreated biomass under conditions sufficient to form a biochar.

One or more aspects of the present disclosure include the method for forming a biochar of the preceding paragraph wherein the biochar comprises iron present in an amount in the range of about 0.10 wt. % to about 30 wt. %, based on total weight of the biochar.

One or more aspects of the present disclosure include the method for forming a biochar of the preceding paragraph wherein the biochar comprises iron present in an amount in the range of about 8 wt. % to about 20 wt. %, based on total weight of the biochar.

One or more aspects of the present disclosure include the method for forming a biochar of any preceding paragraph wherein the pretreatment solution comprises at least one ferrous salt.

One or more aspects of the present disclosure include the method for forming a biochar of any preceding paragraph wherein the pretreatment solution comprises at least one ferrous salt comprises at least one selected from the group consisting of ferrous sulfate, ferrous chloride, ferrous nitrate, and any combination of two or more of the foregoing.

One or more aspects of the present disclosure include the method for forming a biochar of any preceding paragraph wherein the pretreatment solution to biomass ratio is from about 2 to about 20, on a weight basis.

One or more aspects of the present disclosure include the method for forming a biochar of any preceding paragraph wherein the pyrolyzing step is carried out at a temperature in the range of about 400° C. to about 700° C.

One or more aspects of the present disclosure include the method for forming a biochar of any preceding paragraph wherein the dehydrating step is carried out at a temperature in the range of about 60° C. to about 120° C.

One or more aspects of the present disclosure include the method for forming a biochar of any preceding paragraph wherein biochar has an ash content present in an amount in the range of about 10 wt. % to about 50 wt. %, based on total weight of the biochar.

One or more aspects of the present disclosure include the method for forming a biochar of any preceding paragraph wherein the biomass comprises one or more materials selected from the group consisting of sugarcane residue, rice straw, rice husk, miscanthus, switch grass, wood chips, and any combination of two or more of the foregoing.

One or more aspects of the present disclosure include the method for forming a biochar of any preceding paragraph wherein the biomass comprises sugarcane residue.

In another aspect, the present disclosure provides a method for using the catalyst composition of any preceding paragraph, the method comprising contacting a waste source comprising a pollutant with the catalyst composition described in any preceding paragraph and hydrogen peroxide to form a reaction mixture, oxidizing at least a portion of the pollutant under conditions sufficient to form an oxidized pollutant or intermediate compound, and separating the oxidized pollutant or intermediate compound from the reaction mixture.

One or more aspects of the present disclosure include the method for using the catalyst composition of the preceding paragraph wherein the reaction mixture has a concentration of the pollutant in the range of from about 0.1 to about 0.5 g/L.

One or more aspects of the present disclosure include the method for using the catalyst composition of any preceding paragraph wherein the reaction mixture has an initial pH in the range of about 3 to about 9.

One or more aspects of the present disclosure include the method for using the catalyst composition of any preceding paragraph wherein the reaction mixture has a concentration of hydrogen peroxide in the range of from about 0.015 to about 0.9 g/L.

One or more aspects of the present disclosure include the method for using the catalyst composition of any preceding paragraph wherein the reaction mixture has a concentration of the biochar in the range of from about 0.1 to about 1.0 g/L.

One or more aspects of the present disclosure include the method for using the catalyst composition of any preceding paragraph wherein the pollutant comprises at least one selected from the group consisting of one or more dyes, one or more antibiotics, one or more polycyclic aromatic hydrocarbons, one or more pesticides, one or more halogens, one or more chemical oxygen demand (COD) compounds, and any combination of two or more of the foregoing.

One or more aspects of the present disclosure include the method for using the catalyst composition of any preceding paragraph wherein the pollutant comprises one or more dyes selected from the group consisting of methylene blue, orange gelb, and any combination of two or more of the foregoing.

One or more aspects of the present disclosure include the method for using the catalyst composition of any preceding paragraph wherein the separating step comprises removing the oxidized pollutant from the waste water by a separation process selected from the group consisting of magnetic separation, centrifuge, filtration, and any combination of two or more of the foregoing.

Another aspect of the present disclosure includes a catalyst composition comprising a biochar prepared by a method for forming a biochar of any preceding paragraph.

While multiple embodiments are disclosed, still other embodiments will become apparent to those skilled in the art from the following detailed description. As will be apparent, certain embodiments, as disclosed herein, are capable of modifications in various obvious aspects, all without departing from the spirit and scope of the claims as presented herein. Accordingly, the drawings and detailed description are to be regarded as illustrative in nature and not restrictive.

### BRIEF DESCRIPTION OF THE SEVERAL VIEWS OF THE DRAWINGS

The claimed subject matter may be understood by reference to the following description taken in conjunction with the accompanying figures, in which like reference numerals identify like elements, and in which:

FIG. 1 illustrates micrographs of iron containing biochar using SEM-EDX.

FIG. 2A illustrates XPS analysis of iron containing biochar: broad scan range.

FIG. 2B illustrates XPS analysis of iron containing biochar: narrow scan of the iron energy region.

FIG. 3A illustrates the effect of H₂O₂ concentration and iron impregnation on the removal rate of methylene blue.

FIG. 3B illustrates the effect of H₂O₂ concentration and iron impregnation on iron released after Fenton reaction of methylene blue.

FIG. 3C illustrates the effect of H₂O₂ concentration and iron impregnation on removal rates of methylene blue/orange gelb.

FIG. 3D illustrates the effect of H₂O₂ concentration and iron impregnation on the concentration of Fe released from Fe—BC with different Fe content after Fenton reaction of orange gelb.

FIG. 4 illustrates the effect of iron containing biochar concentration on a Fenton reaction with iron containing biochar.

FIG. 5 illustrates the effect of initial methylene blue concentration on a Fenton reaction with iron containing biochar.

FIG. 6 illustrates the effect of initial pH on a Fenton reaction with iron containing biochar.

FIG. 7A illustrates the effect of consecutive experiments on a Fenton reaction with iron containing biochar. Removal rate of methylene blue by separated iron containing biochar in solution, (B) Concentration of iron released during consecutive reaction and (C) Concentration of remaining methylene blue after consecutive reaction without separation the iron containing biochar.

FIG. 7B illustrates the effect of consecutive experiments on a Fenton reaction with iron containing biochar. Concentration of iron released during consecutive reaction.

FIG. 7C illustrates the effect of consecutive experiments on a Fenton reaction with iron containing biochar. Concentration of remaining methylene blue after consecutive reaction without separation the iron containing biochar.

FIG. 8 illustrates the removal rate of orange gelb during consecutive experiments in Fenton oxidation with iron containing biochar.

FIG. 9A illustrates reaction kinetics of methylene blue in Fenton reaction under different treatments.

FIG. 9B illustrates reaction time on orange gelb removal influenced by different ratio of H₂O₂/catalyst dose during consecutive Fenton oxidation with iron containing biochar.

The accompanying drawings illustrate specific embodiments. However, it is to be understood that these embodiments are not intended to be exhaustive, nor limiting of the disclosure. These specific embodiments are but examples of some of the forms in which the disclosure may be practiced. Like reference numbers or symbols employed across the several figures are employed to refer to like parts or components illustrated therein.

### DETAILED DESCRIPTION

Disclosed herein are compositions comprising a biochar; and related methods.

### 1. METHOD(S) FOR FORMING A BIOCHAR FROM A PRETREATED BIOMASS

A method for forming a biochar comprises impregnating a biomass with a pretreatment solution comprising an iron containing compound to form a pretreated biomass. In an aspect, the pretreatment solution to biomass ratio may be present in the range from about 2 to about 20, on a weight basis. In another aspect, the pretreatment solution to biomass ratio may be present in the range from 5 to 20, on a weight basis.

The biomass can be selected from a variety of sources, for example, an organic material, such as plant material, cellulosic materials, lignin containing material, agricultural waste, other naturally derived sources of carbon, or any combination thereof. Examples of a suitable biomass include without limitation one or more materials selected from the group consisting of sugarcane residue, rice straw, rice husk, miscanthus, switch grass, wood chips, and any combination of two or more of the foregoing.

In an aspect, the iron containing compound in the pretreatment solution comprises at least one ferrous salt. Examples of a suitable at least one ferrous salt include without limitation at least one selected from the group consisting of ferrous sulfate, ferrous chloride, ferrous nitrate, and any combination of two or more of the foregoing.

The method further comprises dehydrating the pretreated biomass. The dehydrating step is carried out at conditions sufficient to remove excess water from the pretreated biomass so as to improve the efficiency of the subsequent pyrolyzing step. In an aspect, the dehydrating step may be carried out at a temperature in the range of about 60° C. to about 120° C. for about 60 minutes to 18 hours, depending on temperature (e.g., lower temperatures for a longer time period and higher temperatures for shorter time period). The dehydrating step may be carried out at a temperature in the range of about 105° C. to about 120° C. for about 60 minutes. The dehydrating step may be carried out using a dehydration unit (e.g., an oven, dryer, and so forth), which may be operated in a batch, continuous, or semi-continuous mode. The dehydrating step may be performed after the biomass is mixed with the pretreatment solution, and before a pyrolyzing step which is described below.

The method further comprises pyrolyzing the pretreated biomass under conditions sufficient to form one or more biochars. The one or more biochars comprise iron. The iron may be present in an amount in the range of about 0.10 wt. % to about 30 wt. %, based on total weight of the biochar. In another aspect, the iron may be present in an amount in the range of about 8 wt. % to about 20 wt. %, based on total weight of the biochar.

In an aspect, the pyrolyzing step may be carried out at a temperature in the range of about 400° C. to about 700° C. for a time period in the range from about 60 minutes to about 240 minutes. The pyrolizing step may be carried out at a temperature in the range of about 550° C. about 650° C. for about 60 minutes. For example, the pyrolyzing step may be carried out by beginning at a first temperature (e.g., room temperature) and increasing to a second temperature (e.g., about 600° C.) at a rate of about 10° C./min and once the second temperature is reached maintain the second temperature for about 4 hours. A shorter time period is generally used with temperatures at the higher end of the range, and a longer time period is generally used with temperatures at the lower end of the range (e.g, about 400° C. for 240 about minutes, and about 700° C. for about 60 minutes). The pyrolyzing step may be carried out using a pyrolysis unit (e.g., a furnace, gasifier or reactor), which can be operated in a batch, continuous, or semi-continuous mode. The pyrolysis unit can include a controller for increasing, decreasing, and/or maintaining the temperature of the pyrolysis unit.

### 2. CATALYST COMPOSITION(S)

In another aspect, the present disclosure provides a catalyst composition comprising a biochar. The catalyst composition may be prepared according to the method for forming a biochar from a pretreated biomass disclosed herein. In an aspect, the biochar comprises iron. The iron may be present in an amount in the range of about 0.10 wt. % to about 30 wt. %, or about 8 wt. % to about 20 wt. %, based on total weight of the biochar.

The biochar may further comprise ash. The ash content may be present in an amount in the range of about 10 wt. % to about 50 wt. %, or about 25 wt. % to about 40 wt. %, based on total weight of the biochar.

In an aspect, the biochar may have a pH in the range of from about 2 to about 7, or 3 to 5.

In an aspect, The biochar can be further characterized in that the biochar is impregnated with the iron that is in the form selected from the group consisting of Fe₃O₄, Fe₂O₃, FeOOH, and any combination of two or more of the foregoing.

In an aspect, the biochar can further comprise a component selected from sulfur, chlorine, nitrogen, and any combination of two or more of the foregoing. In an aspect, the component may be present in an amount in the range of 0.02 wt. % to about 10 wt. %, based on total weight of the biochar.

In an aspect, the biochar can be further characterized in that the biochar has a surface area in the range of about 170 to about 230 m²/g.

In an aspect, the biochar can be further characterized in that the biochar has a total pore volume in the range of about 0.1 to about 0.2 cm³/g.

### 3. METHOD(S) FOR USING CATALYST COMPOSITION(S)

In another aspect, the present disclosure provides a method for using the catalyst compositions disclosed herein. The method comprises contacting a waste source comprising a pollutant with the catalyst composition described herein and hydrogen peroxide to form a reaction mixture.

The concentration of hydrogen peroxide and biochar are in an amount sufficient to oxidize the pollutant so as to achieve a desired amount of pollutant removal from the waste source. In an aspect, the reaction mixture may contain a concentration of hydrogen peroxide in the range of from about 0.015 to about 0.9 g/L. The reaction mixture may contain a concentration of the biochar in the range of from about 0.1 to about 1.0 g/L. The concentration of the pollutant may be in the range of from about 0.1 to about 0.5 g/L.

In an aspect, the initial pH of the reaction mixture is a value sufficient to oxidize the pollutant. In an aspect, the initial pH of the reaction mixture is in the range of about 3 to about 9.

The pollutant comprises at least one selected from the group consisting of one or more dyes, one or more antibiotics, one or more polycyclic aromatic hydrocarbons, one or more pesticides, one or more halogens, one or more chemical oxygen demand (COD) compounds, and any combination of two or more of the foregoing. Examples of one or more dyes include without limitation one or more dyes selected from the group consisting of methylene blue, orange gelb, and any combination of two or more of the foregoing.

The method further comprises oxidizing at least a portion of the pollutant under conditions sufficient to form an oxidized pollutant or intermediate compound. The method further comprises separating the oxidized pollutant or intermediate compound from the reaction mixture. In an aspect, the separating step comprises removing the oxidized pollutant from the waste water by a separation process that comprises magnetic separation (e.g., using a magnet). In addition to or alternatively, additional separation methods can be used in the separating step, for example, separation by centrifuge, filtration, or any combination of two or more of the foregoing.

### 4. EXAMPLES

The present disclosure can be better understood by reference to the following examples, which are presented for purposes of illustration and are not intended to limit the scope of the present disclosure.

### 4.1 Experimental Setup.

### 4.1.1 Biomass and Preparation Thereof.

Biomass in the form of sugarcane residue was collected from Louisiana State University AgCenter Sugar Research Station at St. Gabriel (Louisiana, USA), and used to produce biochar in accordance with this disclosure. The sugarcane residue was rinsed with deionized (DI) water, oven-dried (at 60° C.), grinded with a grinder, and then the ground biomass was passed through a sieve (<0.5 mm). The pretreated biomass was prepared by impregnating the biomass with a pretreatment solution and pyrolyzing the pretreated biomass. Specifically, 30 g of sugarcane residue was impregnated with 500 mL of 0.5M FeSO₄.7H₂O solution to form a mixed solution. The mixed solution was stirred for 24 hours to form a pretreated biomass, and then subjected to a dehydrating step via drying in an oven at 60° C. for 24 hours. The dried pretreated biomass was placed in porcelain crucibles with a cover and pyrolyzed in a muffle furnace (FA 1730; Thermolyne Sybron Corporation, Dubuque, Iowa) under limited oxygen conditions with nitrogen gas purged. The controller of the furnace was programmed to drive the internal biomass chamber temperature to 600° C. at approximately 10° C./minutes and held for 4 hours. The resulting iron containing biochar was cooled and stored in an airtight container before use.

The elemental content of the iron containing biochar was determined by inductively coupled plasma-atomic emission spectrometry (ICP-AES) after digestion using EPA 3050B. X-ray photoelectron spectroscopy (XPS) using a Kratos AXIS Ultra DLD spectroscopy with an Al, K X-ray source was employed for iron analysis on the surface of the iron containing biochar. Finally, microscopic features and morphology of iron containing biochar were measured with a field emission gun scanning electron microscopy (FEG-SEM, JEOL 6335 F, Japan) equipped with energy dispersive X-ray (EDX) spectroscopy.

### 4.1.2. Heterogeneous Fenton Oxidation Activities by Iron Containing Biochar

Heterogeneous Fenton reactions were carried out using different dosages of iron containing biochar, hydrogen peroxide, and pollutant in the reaction mixture. The reaction mixture contained iron containing biochar in a concentration in the range of from 0.1 to 1.0 g/L, a concentration of hydrogen peroxide in the range of 0.015 to 0.900 g/L, and methylene blue as the pollutant in a concentration in the range of 0.1 to 0.5 g/L and pH in the range of 3 to 9.

The stability and recyclability of iron containing biochar were evaluated by successive tests of methylene blue removal. The iron containing biochar after first reaction was separated by a magnetic bar from the mixed solution. The removal velocity of methylene blue was carried out by preparing samples by weighing 0.5 g/L of iron containing biochar in glass Erlenmeyer flasks followed by addition of 100 mL of solution containing 0.1 g/L of methylene blue. The initial pH value was adjusted to 4 by drop-wise addition of 0.1 M hydrochloric acid or sodium hydroxide solutions with stirring followed with addition of 0.075 g/L H₂O₂. The samples were allowed to react at different time internals up to 8 hours under stirring at constant room temperature (25° C.). After reaction, the samples were centrifuged at 4000 rpm for 10 minutes, and the supernatants were analyzed for the residual methylene blue concentration using a Thermo Scientific EVO 60 visible-spectrophotometer (USA) at 668 nm. The pH of the methylene blue solution was determined using an OAKTON pH meter (USA). The concentration of iron released in solution after reaction was analyzed by inductively coupled plasma-atomic emission spectrometry (ICP-AES).

### 5. RESULTS

5.1 Characteristics of Biochar Formed from Pretreated Biomass.

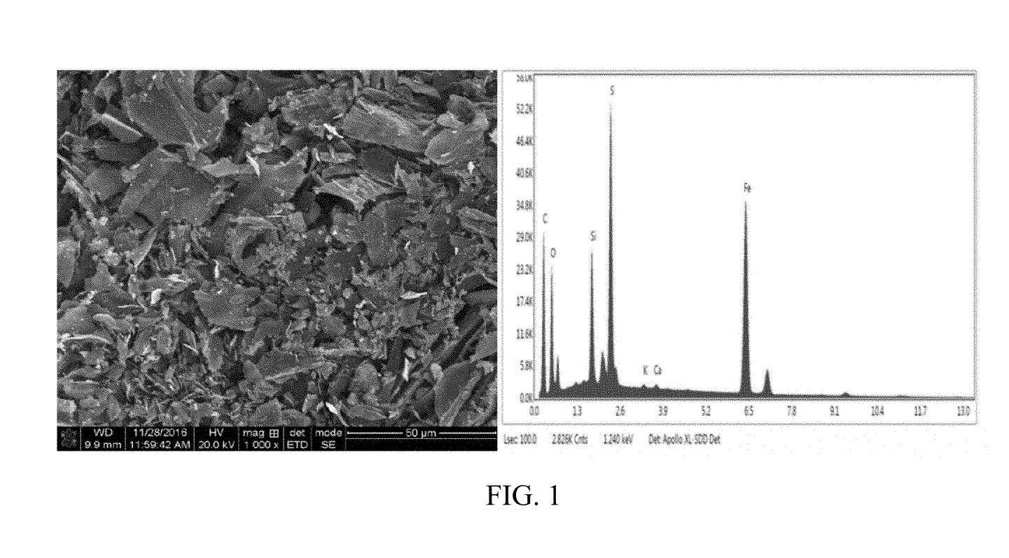

The main properties of the iron containing biochar obtained are shown in Table 1. The bulk elemental composition of iron containing biochar, as determined by ICP-AES, was as follows: Fe (16.3%), S (9.72%), Ca (3.01%), K (0.57%) and Mg (0.40%). The micrographs can be described using FEG-SEM, which provides information about the structural changes of iron containing biochar. As shown in FIG. 1, small particles were aggregated on the iron containing biochar surface, likely due to impregnation of ferrous sulfate. EDX spectra also demonstrated the presence of iron and sulfur ions on the surface of the iron containing biochar along with carbon and oxygen which are predominant elements in the iron containing biochar.

TABLE 1
Characteristics of Iron Containing Biochar (Fe—BC)

| Characteristics | Values |
|---|---|
| Yield (%) | 37.1 |
| Ash (%) | 32.6 |
| Total acidity (meq/g) | 1.8 |
| Surface area (m²/g) | 179.5 |
| Total pore volume (cm³/g) | 0.1502 |
| Micropore volume (cm³/g) | 0.0758 |
| Macropore volume (cm³/g) | 0.0725 |
| pH (1:20) | 3.1 |
| C (%) | 42.5 |
| N (%) | 1.5 |
| S (%) | 9.7 |
| P (%) | 0.17 |
| Fe (%) | 16.3 |
| K (%) | 0.57 |
| Ca (%) | 3.01 |
| Mg (%) | 0.40 |
| Na (%) | 0.03 |
| Al (%) | 0.03 |
| Mn (%) | 0.02 |

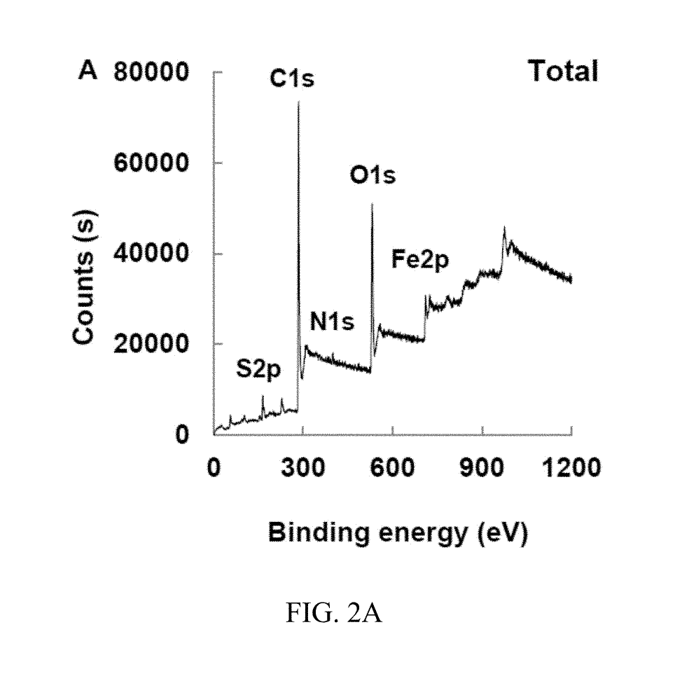

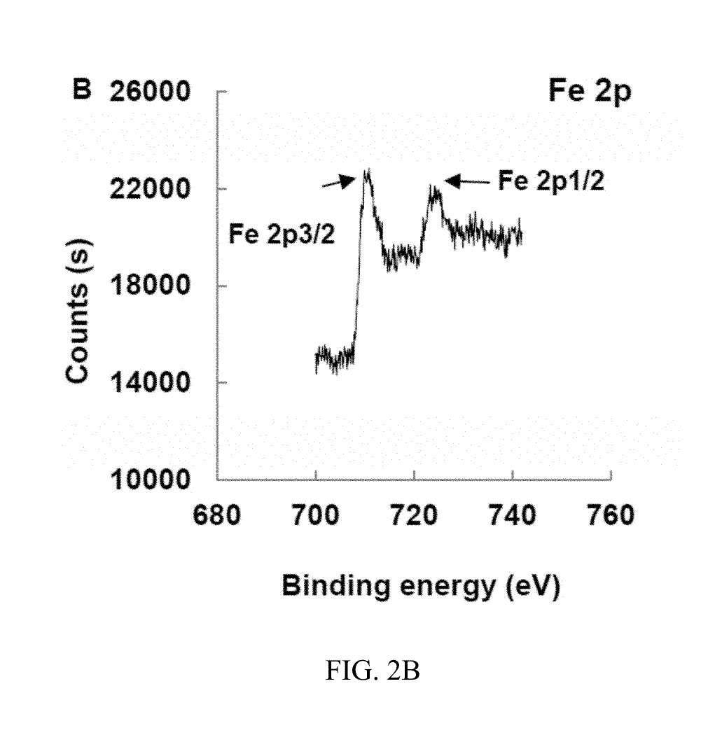

The iron containing biochar was analyzed using XPS to verify the interaction between iron and the biochar. Broad and narrow scans for total and Fe2p peaks of iron containing biochar are shown in FIG. 2. The wide scan spectra of the iron containing biochar illustrated photoelectron lines at binding energies of 163.4, 284.5, 400.0, 529.8 and 710.7 eV which are assigned to S2p, C1s, N1s, O1s, and Fe2p, respectively (FIG. 2A). High resolution XPS profiles of S2p and Fe2p exhibited asymmetric character, indicating the presences of different kinds of surface sulfur and ferric species on iron containing biochar [24,25]. XPS analysis of the iron containing biochar showed that the binding energies of Fe2p3/2 at 209.3 eV, 710.7 eV, and 712.2 eV and Fe2p1/2 around 724.3 eV, respectively (FIG. 2B). Since the binding energies related to Fe²⁺ and Fe³ of Fe2p3/2 are assigned at 709 eV and 711 eV [26] and the Fe2p1/2 peaks around 724 eV are generally associated with Fe₂O₃ and FeOOH [27,28], these observations indicated the presence of Fe₃O₄, FeOOH and Fe₂O₃ mixtures on the developed FSB surface [26,27,28]. In the case of sulfur, the peaks at 163.7 eV can be attributed to elemental sulfur and thiol groups, while the peaks at 168.4 eV is concordant with both sulfate and sulfoxide groups [29].

### 5.2. Heterogeneous Fenton Oxidation Activities by Iron Containing Biochar

### 5.2.1. Effect of Hydrogen Peroxide.

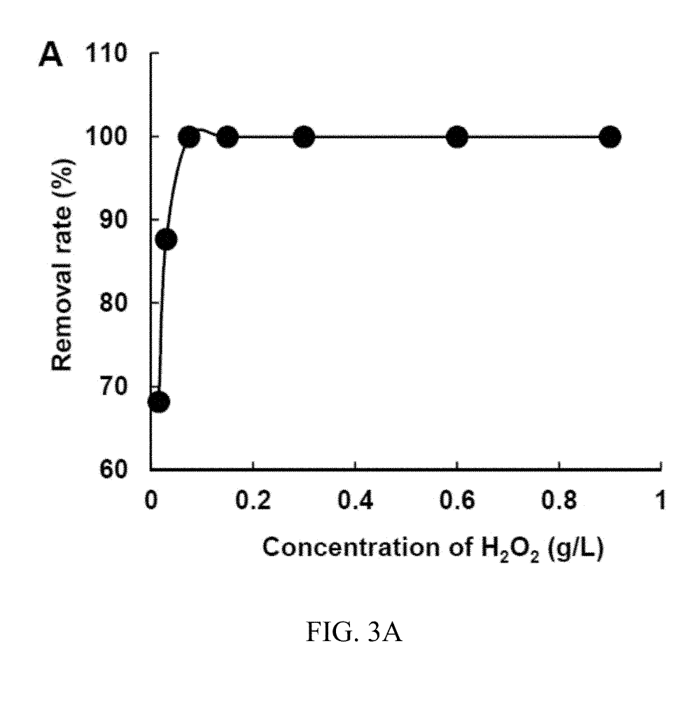

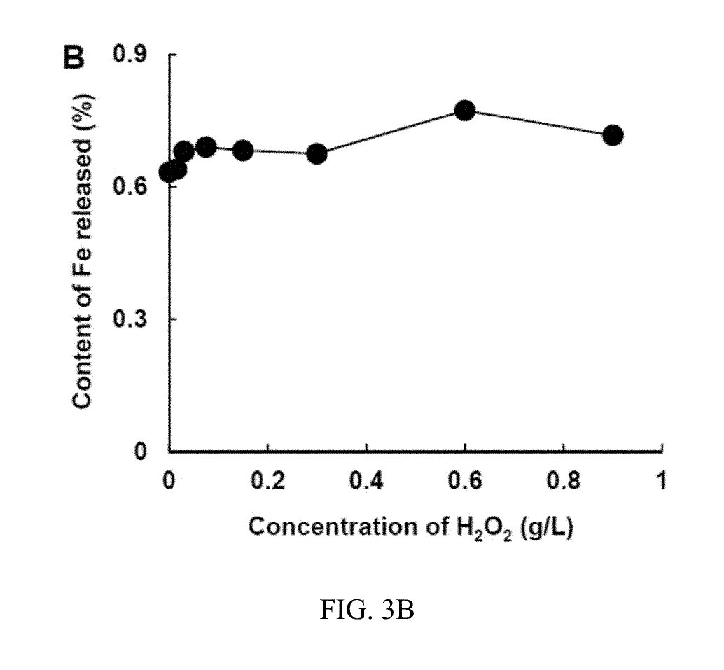

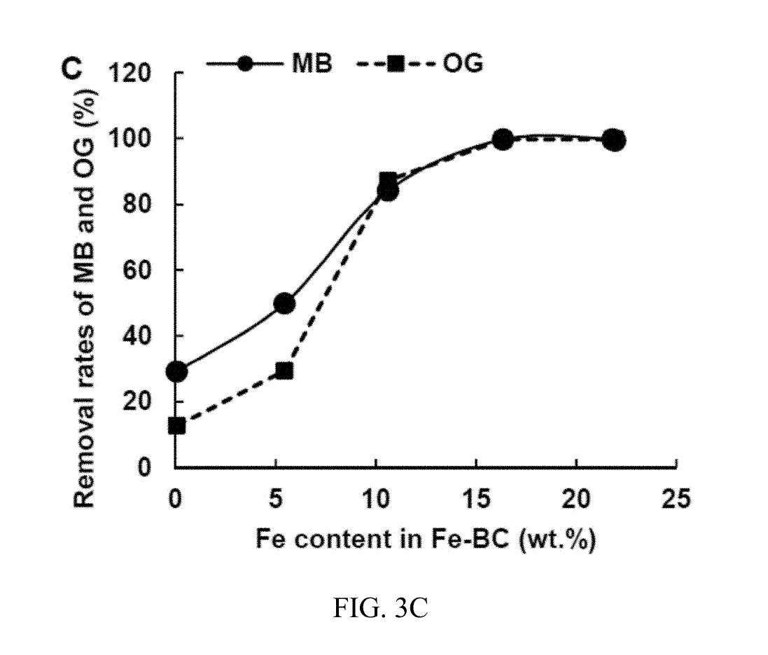

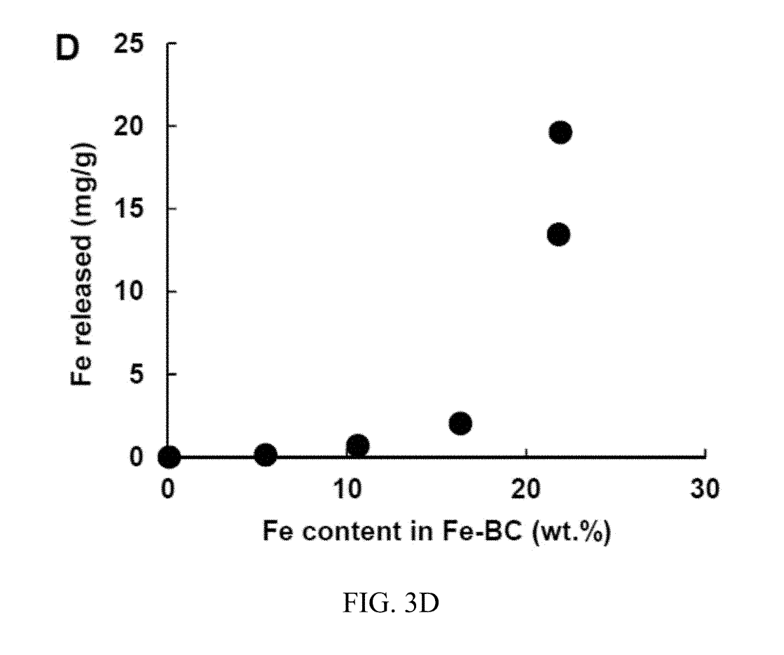

The effect of the concentration of hydrogen peroxide on methylene blue removal by the iron containing biochar was investigated over a hydrogen peroxide range of 0.006 to 0.075 g/L with and initial concentration of methylene blue of 0.1 g/L, and a concentration of iron containing biochar of 0.5 g/L at initial pH 4 (FIG. 3A). At low concentrations of hydrogen peroxide, e.g., 0.006 and 0.025 g/L, the removal efficiencies of methylene blue were low because of the insufficient OH. in the aqueous solution. As the concentration of hydrogen peroxide increased to 0.050 g/L, the removal efficiencies of methylene blue was enhanced, and at a concentration of hydrogen peroxide of 0.075 g/L the methylene blue was completely or nearly completely removed, since more OH. radicals were formed.

Without intending to be bound by this theory, an optimum concentration of hydrogen peroxide in a Fenton reaction for the removal of methylene blue might be explained as follows. The HO. radicals attack the benzene ring of the organic pollutants at low concentrations of hydrogen peroxide. However, there is a competition between the substrate and hydrogen peroxide at high concentrations of hydrogen peroxide, due to that hydrogen peroxide at high concentration acting as a scavenger of the highly potent HO. radicals to produce perhydroxyl radical (HO₂.) (Eq. 4). The HO₂. radical is rather innocent towards redox act. It not only has lower oxidation activity than HO., but also decreases in the number of OH. radicals in solution due to self-quenching reaction of OH. radicals (Eq. 5) [30, 31].

H₂O₂+HO.→HO₂.+H₂O₂ (Eq.4)

H₂O₂.+HO.→H₂O+O₂ (Eq. 5)

For this reason, it has been reported that as the amount of hydrogen peroxide increases, the removal efficiency of the organic pollutants by the Fenton oxidation decreases [32]. However, in these experiments, the removal efficiency of methylene blue was not decreased, but maintained fairly constant at a hydrogen peroxide concentration above 0.075 g/L It has also been reported that there is almost no effect of the initial H₂O₂ concentration in a heterogeneous Fenton reaction with pillared clay-based catalyst, possibly because the maximum level of removal efficiency was already attained [33].

The content of iron released in solution from iron containing biochar under different concentrations of hydrogen peroxide is illustrated in FIG. 3B. The content of iron released in the concentration of H₂O₂ ranged from 0.006 to 0.090 g/L was between 0.64 to 0.77%. Generally, while iron leaching increases by increasing hydrogen peroxide concentration, there was just a slight increase of iron leaching observed compared to the reaction without H₂O₂ (0.63%) in this study. It has been reported that the releasing of iron from iron impregnated catalysts during a heterogeneous Fenton reaction is not a simple dissolution process only associated with the acidic condition of solution, but it is a complex mechanism between iron forms present in solid matrix and peroxides during the catalytic process [33]. It has also been reported that the parent compound also influences the complex mechanism of iron release [34]. On the other hand, under fixed concentration of H₂O₂, at 0.075 g/L, the significant leaching loss of Fe in solution after reaction only occurred when the impregnated Fe content was >16.3% (FIG. 3C, and FIG. 3D), indicating optimum impregnation Fe use efficiency at 16.3% Fe for iron containing biochar (Fe—BC). The later showed that the Fe concentration released in reaction solution during the heterogeneous Fenton oxidation of methylene blue and orange gelb was <2 mg/L, meeting effluent water quality standard of this experimental set-up.

The hydrogen peroxide concentration should be controlled in an amount sufficient for the removal of wastewater, however, a high hydrogen peroxide concentration could be detrimental and likely increase the operational cost of the wastewater treatment. According to the results above, an optimum hydrogen peroxide concentration for the most effective removal of 0.1 g/L MB is 0.075 g/L or at the ratio of 1.33 part methylene blue per part of hydrogen peroxide in a heterogeneous Fenton reaction with the iron containing biochar.

### 5.2.2 Effect of Biochar.

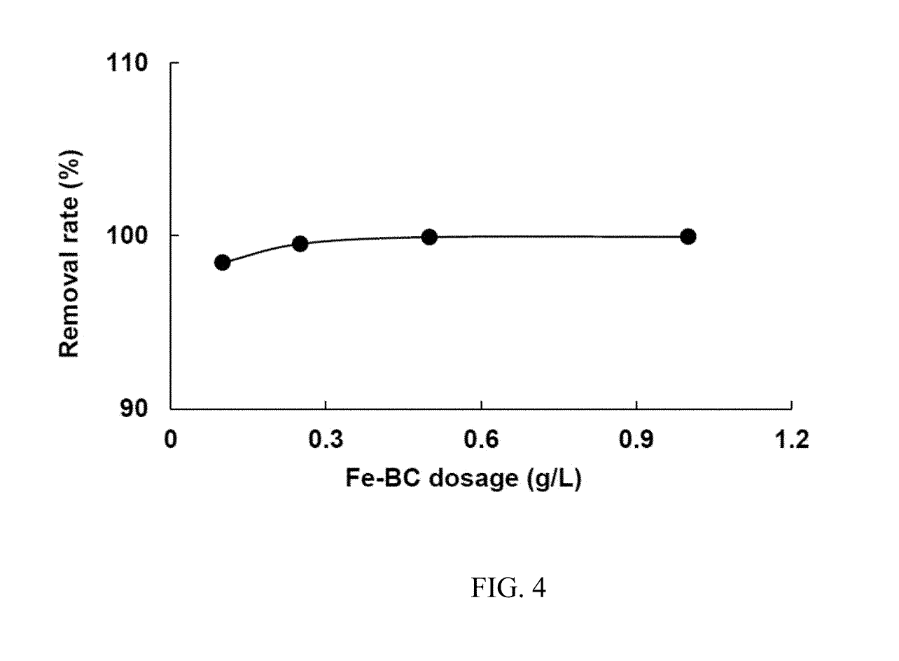

The effect of the iron containing biochar concentration on methylene blue removal was investigated over the range of 0.1 to 1.0 g/L, an initial methylene blue concentration of 0.1 g/L, and a hydrogen peroxide concentration of 0.075 g/L at an initial pH 4. The results are illustrated in FIG. 4. By increasing iron containing biochar concentration from 0.1 to 1 g/L, methylene blue removal efficiency was improved. The removal efficiency was almost 100% with iron containing biochar concentration between 0.5 g/L and 1.0 g/L The results indicate that the removal efficiency of methylene blue increases as the iron containing biochar concentration increases, which is likely due to the increased generation of OH. radicals by an enhancement in the rate of decomposition of hydrogen peroxide. However, high catalyst dosage can induce the coagulation of catalysts and the scavenging of OH. radicals by unsuitable reaction (Eq. 6) [35].

Fe²⁺+OH.→Fe³⁺+OH (Eq. 6)

Considering the removal efficiency and the cost of iron containing biochar, an optimum concentration of iron impregnated biochar for methylene blue removal could be about 0.5 g/L This amount is lower than that reported for other iron-containing solid supports such as activated carbon, pillared clay and bentonite [8,18,36]. Therefore, this suggests that iron containing biochar, as disclosed herein, produces superior results in terms of economy and efficiency when applied to actual wastewater treatment, as compared to other iron-containing solid support.

### 5.2.3. Effect of Methylene Blue Concentration.

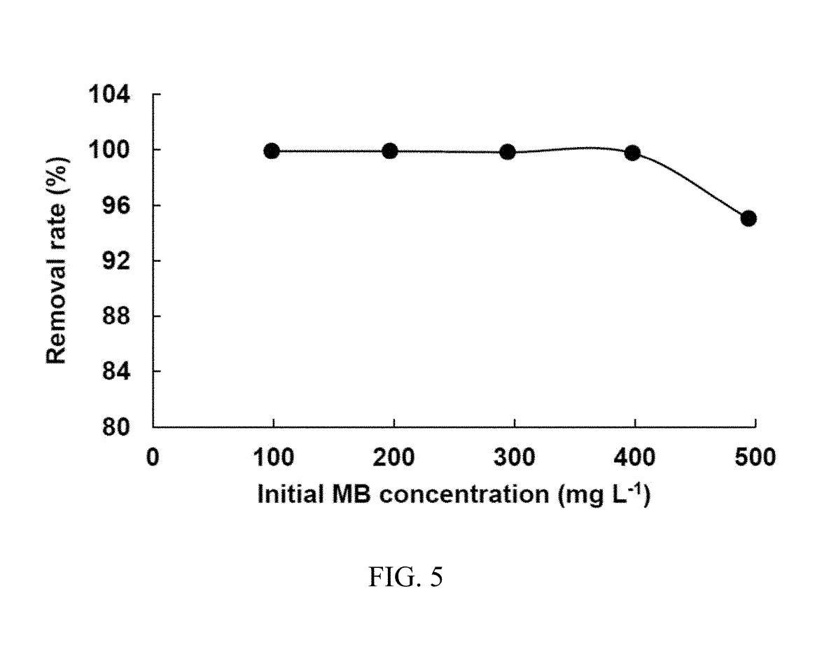

The effect of initial concentration of methylene blue on methylene blue removal was investigated over the range of 0.1 to 0.5 g/L, and initial iron containing biochar concentration of 0.5 g/L, and a hydrogen peroxide concentration of 0.075 g/L at the initial pH 4. The results are shown in FIG. 5. As the methylene blue concentration is increased from 0.1 g/L to 0.5 g/L, the removal efficiency decreased from 99.9% to 95.0% for a Fenton reaction with iron containing biochar. The removal efficiency of methylene blue was stable up to 0.4 g/L, but decreased at 0.5 g/L. This is likely because the concentration of methylene blue increased while the amount of iron containing biochar and hydrogen peroxide remained the same, so that sufficient OH. is not generated for removing methylene blue, which led to a decreasing of the removal efficiency of methylene blue. On the other hand, such a situation of low activity of catalysts in high concentration of pollutants could be regarded as the induction period in heterogeneous reaction. It has been reported that this induction period is probably related to intermediate oxidation products that capture radicals, as reported in phenol oxidation reaction [33]. In the case of higher pollutant concentration, such intermediates are formed in higher concentrations. When these intermediates disappear, the activity of the catalyst would increase again [37]. The formation of degradation intermediates derived from the initial modification of the central aromatic ring and their subsequent metabolites has been demonstrated for the methylene blue oxidation process by OH. radical induced heterogeneous Fenton reaction [38]. In this pathway, the OH. and OOH. radicals produced from a Fenton reaction can be consumed by the parent compound and degradation intermediates and their subsequent metabolites, and their competition is closely related to the removal efficiency of methylene blue.

### 5.2.4. Effect of Initial pH.

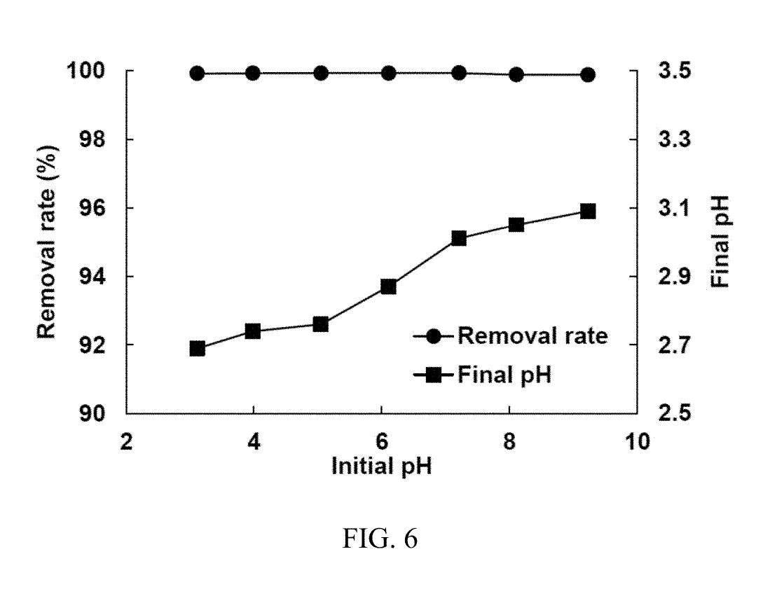

In addition to improving catalytic activity, another goal of developing the new heterogeneous Fenton oxidation catalysts is to extend the pH range of application. The effect of initial pH on the removal of methylene blue by the iron containing biochar with hydrogen peroxide was investigated at different solution pHs ranging from 3 to 9 (iron containing biochar concentration=0.5 g/L, initial methylene blue concentration=0.1 g/L and hydrogen peroxide concentration=0.075 g/L). As shown in FIG. 6, with the increase of initial pH, the removal rate of methylene blue did not decrease. Over a pH range of 3 to 9, the removal rate of methylene blue was 99% within 3 minutes of the reaction.

In general, the OH. radicals, as major oxidant for the removal of organic pollutants, are generated by Fenton reaction (Eq. 1) [41]. However, a weaker oxidant such as ferryl ion (e.g., FeO²⁺) that is more selective than OH. radical may be formed by reaction at a pH of above 5 (Eq. 7) [42].

Fe²⁺+H₂O₂→Fe(IV)(e.g.,FeOt²⁺)+H₂O (Eq. 7)

Additionally, the reduced oxidation efficiency at high pH values can be attributed to the decomposition of H₂O₂, the lower oxidation potential of OH. radicals, and the deactivation of catalyst with the formation of ferric hydroxide complexes inducing to a reduction of OH. [43,44]. On the other hand, in a homogeneous phase, lower pH values result in decreasing the concentration of Fe(OH)²⁺, while higher pH values result in precipitation of oxyhydroxides [45], both negatively affecting catalytic performance. However, the activity of iron containing biochar for methylene blue removal in the neutral initial pH range observed in results was higher than that of many reported heterogeneous and homogeneous Fenton oxidation catalysts [46,47].

The final pH of solution after Fenton oxidation reaction with iron containing biochar observed in the results rapidly decreased to the range of 2.60 to 3.09 (initial pH range of 3.11-9.23), which is probably due to the formation of some acidic reaction intermediates. Dutta et al. [47] and Feng et al. [32] reported similar results for the removal of methylene blue and Orange II by Fenton oxidation reaction. Another possible reason for the change in solution pH is that the formation of SO₄², NO₂⁻, and Cl⁻ during the mineralization of methylene blue also generates acidity [48]. For at least this reason, the removal efficiency of methylene blue by the iron containing biochar is considered to be high even though the pH in solution is increased. Thus, no or less pH adjustment of the dye wastewater is needed for effective oxidation over the wider pH range, which is an important advantage for application of the iron containing biochar disclose herein in treating a waste source such as wastewater.

### 5.2.5. Stability and Reuse of Iron Containing Biochar.

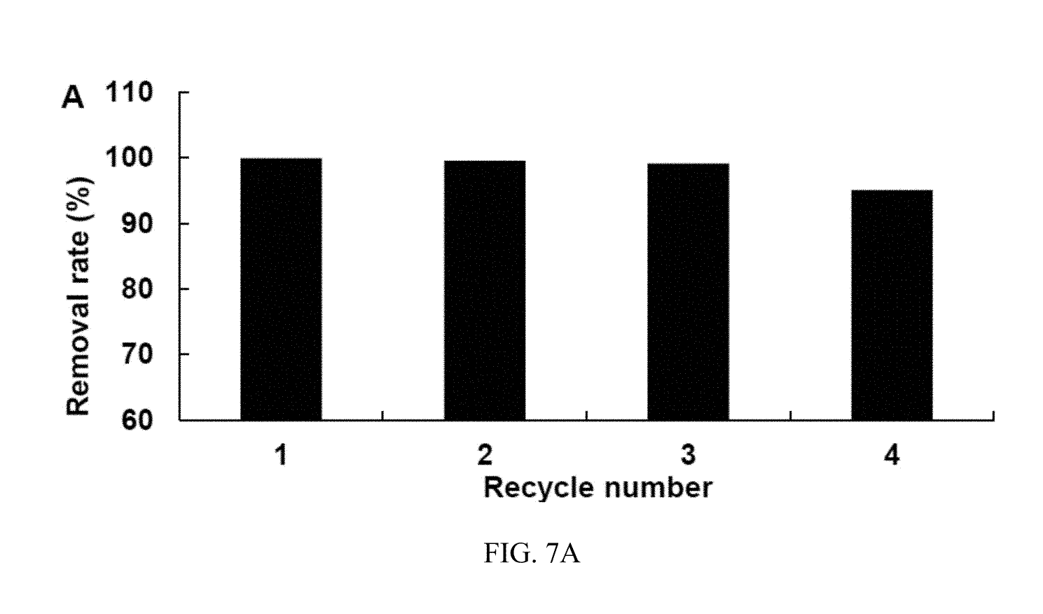

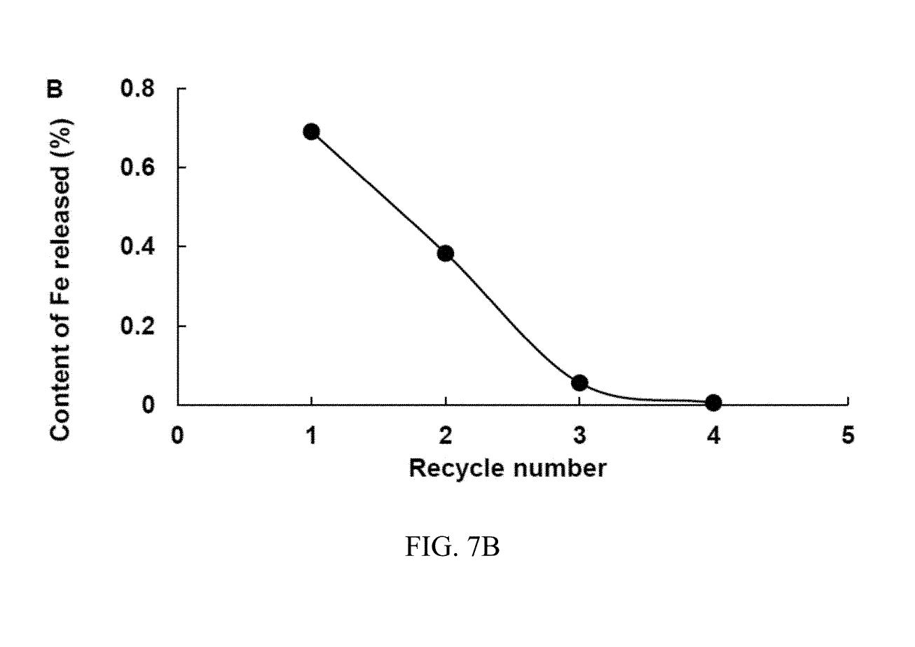

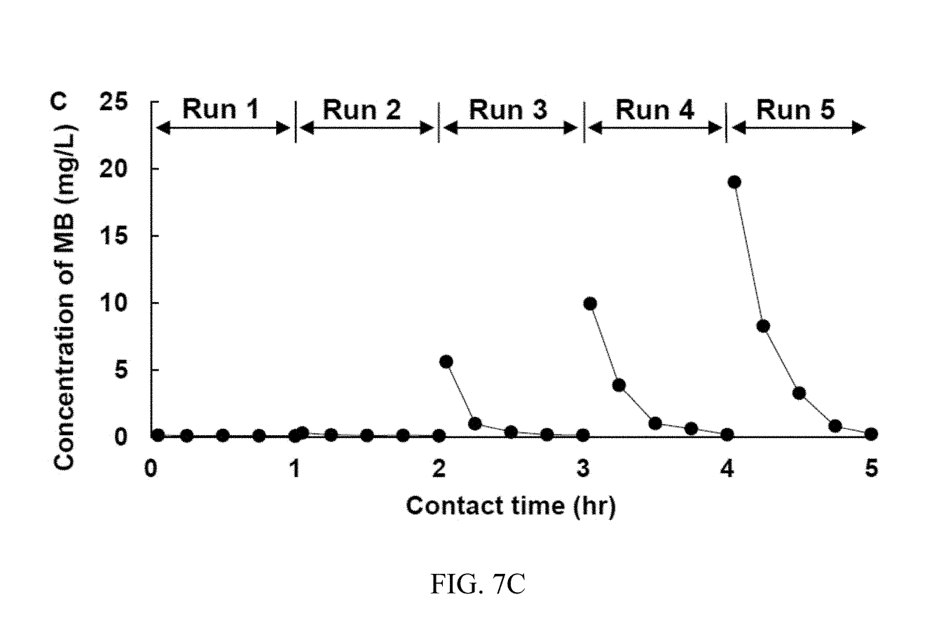

The stability and reuse experiments were conducted to evaluate the catalytic activity of iron containing biochar during successive reactions and to assess the possibility of the reuse of iron containing biochar. Many studies have reported that iron-containing catalysts can be separated from the final effluent through filter paper for reuse, even though they might have magnetic characteristics [8,49,50]. However, the activity of such separated catalysts may be overestimated as compared to the case where the catalysts are applied to the actual wastewater treatment process. To recover the catalyst in our study, the catalysts in the final effluent were separated using a magnetic bar. After the first run, both methylene blue and hydrogen peroxide were added to maintain the same concentration for successive evaluation of iron containing biochar catalyst as in the initial experiment. As shown in FIG. 7A, catalyst activity is only slightly decreased with the removal rates of methylene blue changed from 99.5 to 95.1% after 4 runs (FIG. 7A). The loss of catalyst activity may be due to the difficulty in completely removing residual byproducts and reactants from active catalyst sites after reaction. Others reported that the catalyst deactivation could also be due to the loss of active catalytic sites caused by the replacement of Fe from the catalyst surface as well as the catalyst itself in solution during successive runs [49,51]. For at least this reason, the iron content in initial and each of successive runs were determined. As shown in FIG. 7B, the content of iron released from iron containing biochar in solution decreased after each reaction with 0.690, 0.383, 0.055 and 0.005% of total iron in the catalyst for 1, 2, 3 and 4 runs (FIG. 7B). These results indicate that even though the amounts of iron released from iron containing biochar in solution are 0.055% and 0.005%, the removal efficiencies of methylene blue are still 99.1% and 95.1%, respectively, because the methylene blue removal by the iron containing biochar is predominantly the heterogeneous Fenton reaction.

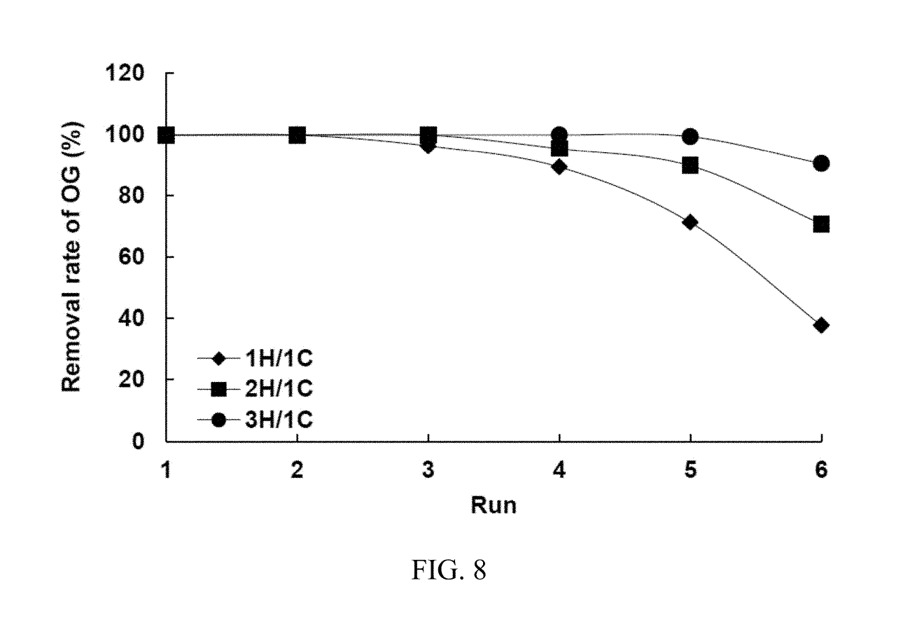

The stability of the iron containing biochar was also evaluated by successive test of methylene blue removal. In this experiment, the iron containing biochar was not separated from the solution, and 100 ml of 0.1 g/L MB and 0.075 g/L of H₂O₂ were added continuously at 1 hr interval. The results are shown in FIG. 7C. During five consecutive runs, the treatment efficiency of methylene blue after one hour of Fenton oxidation was greater than 99%. However, the removal efficiency of methylene blue reached 99% within 3 minutes during two runs, while the initial treatment efficiency of MB in 3, 4, and 5 runs was 94, 89, and 80% at 3, 4, and 5 runs, respectively. It is likely that the activity of the catalyst was decreased due to the accumulation of the reaction intermediates decomposed from methylene blue as the number of reactions increased. On the other hand, the removal efficiency of orange gelb by Fe—BC maintained >89.3% after at least 4 consecutive runs at similar dose of H₂O₂ (FIG. 8). These test results suggest that the developed iron containing biochar can be easily and quickly recovered from wastewater effluents and reuse efficiently for treating methylene blue, orange gelb and pollutants with similar characteristics.

### 5.2.6. Removal Velocity of Iron Containing Biochar.

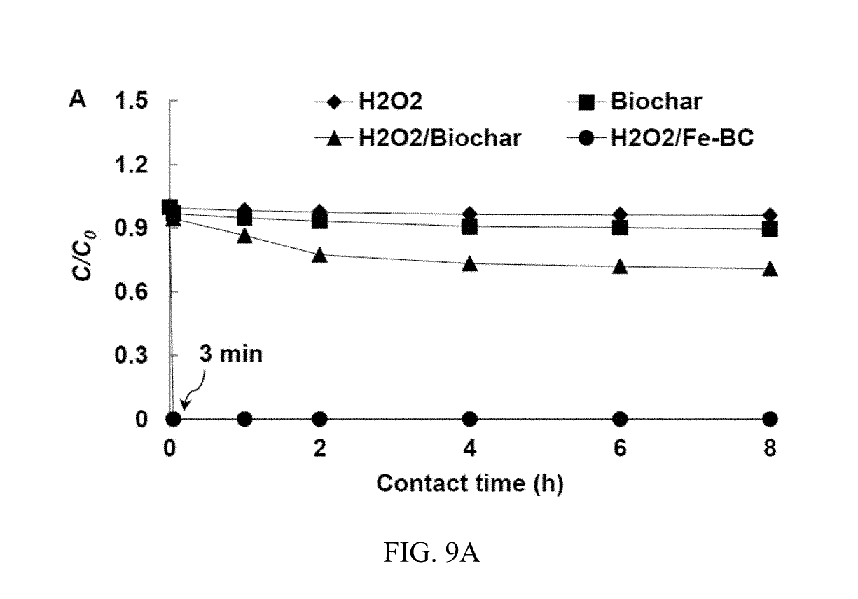

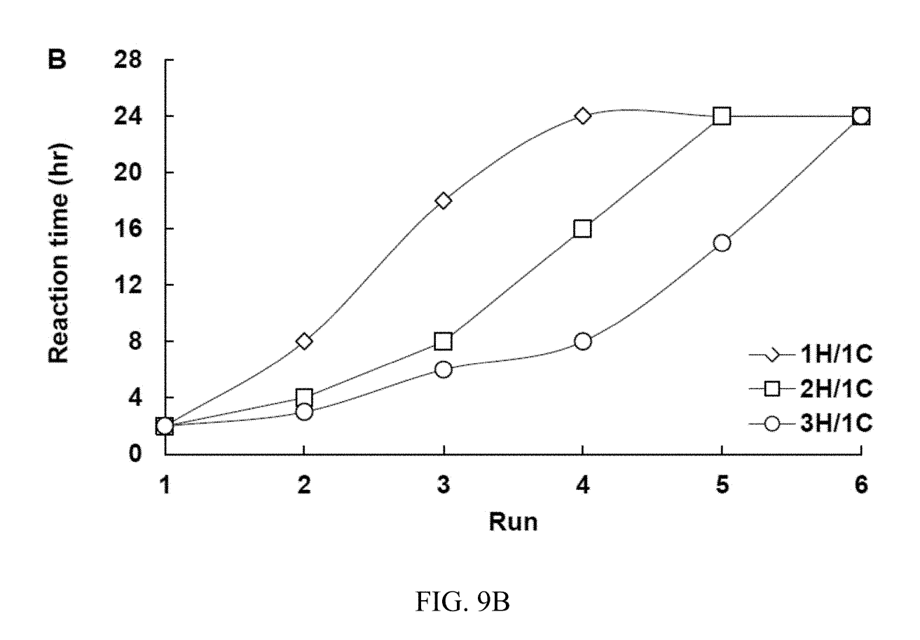

This experiment evaluated the effect of hydrogen peroxide and iron containing biochar on the removal velocity of methylene blue. For comparison purposes, the methylene blue removal by biochar, H₂O₂ biochar with H₂O₂ (biochar/H₂O₂) along with iron containing biochar and H₂O₂ were also determined. As shown in FIG. 9A, the removal rate of methylene blue by biochar after 8 h reaction was only 10.3%, indicating that the removal of methylene blue was probably impacted by biochar surface adsorption. The same experiment with only 0.075 g/L H₂O₂ at initial pH 4 was found to hardly degrade methylene blue (removal rate 4.1%). The removal rate of methylene blue in biochar/H₂O₂ treatment was 29.1%. Carbon based material has been applied as a solid catalyst in the Fenton oxidation reaction due to the presence of polyaromatic moieties and functional group [36]. One possible mechanism suggested for the interaction of biochar with H₂O₂ is to replace surface hydroxyl groups by hydroperoxyl groups that are stronger oxidants because of bonding with biochar, which becomes reduced by another H₂O₂ molecule in the liquid phase to generate OH. radical and regenerate the initial surface hydroxyl group [49]. On the other hand, the simultaneous presence of 0.5 g/L iron containing biochar and 0.075 g/L H₂O₂ could remove completely methylene blue within about 3 minutes (FIG. 9A) and orange gelb with 2 hrs (FIG. 9B), clearly indicating the high catalytic ability of iron containing biochar to the H₂O₂ activation.

Removal rate of MB has been determined by linear velocity equation, which is expressed by V= [symbol] C [53]. The reaction is associated with methylene blue concentration and the instantaneous [symbol] reaction velocity (V), which can be expressed as −dC/dt at V when V= [symbol] C. Linear velocity equation (Eq. 9) is an integrated calculus linear velocity equation (Eq. 8).

−dC/dt= [symbol] C (Eq. 8)

ln(C/Cₒ)=− [symbol] t(Eq.9)

where Cₒ and C (mg/L) are the concentration of methylene blue in solution before and after reaction, respectively, t is reaction time (hr) and [symbol] is the methylene blue removal velocity constant.

The reaction rate (C/Cₒ) curves expressed in terms of C/Cₒ and reaction time (hr), for methylene blue removal under different treatments, are shown in FIG. 8. Each reaction curve was separated into two zones based on fast and slow reaction (H₂O₂, biochar and H₂O₂/biochar at 0-4 hr and 4-8 hr, H₂O₂/iron containing biochar at 0-3 minutes and 3 minutes-8 hr). For each treatment, two linear regression equations were applied. Using reaction rate (C/Cₒ), the removal velocity constants of methylene blue under different treatment are shown in Table 2. The removal velocities of methylene blue in the H₂O₂, biochar, H₂O₂/biochar and H₂O₂/iron containing biochar were expressed as linear regression of methylene blue concentrations change with time. At the first zone, the removal velocity constants ( [symbol] ) of methylene blue in H₂O₂, biochar, H₂O₂/biochar and H₂O₂/iron containing biochar (Fe—BC) were 0.008, 0.020, 0.074 and 143.740 hr⁻¹, respectively. The removal velocity of methylene blue was rapid in the following order of H₂O₂/Fe—BC>H₂O₂/biochar>biochar>H₂O₂.

The removal velocity constants (k) of methylene blue in second zone of H₂O₂, biochar, H₂O₂/biochar and H₂O₂/Fe—BC were 0.0012, 0.0033, 0.0083 and 0.0412 hr⁻¹, respectively. The removal velocity of methylene blue in second zone was rapid the following order H₂O₂/Fe—BC>H₂O₂/biochar>biochar>H₂O₂.

The removal velocity of methylene blue by H₂O₂/Fe—BC in first zone was much higher than that of second zone. Generally, the removal velocity can be divided in two zones: a fast first zone followed by a slow second zone. This phenomenon was also observed in the homogeneous Fenton reaction and can be explained considering that H₂O₂ reacts rapidly with iron oxide on the supporter surface to generate a large amount of OH. radicals. The OH. radicals generated can react rapidly with the organic pollutants. The oxidized iron on the supporter surface produced in the first stage could react with H₂O₂ to produce OH₂. radicals and recycling the catalyst on the supporter surface (Eq. 2 and 3). As the OH₂. radicals are less oxidative than the OH. radicals [54], a slow second zone occurs. However, the iron containing biochar used in this experiment contains a large amount of iron oxide on the surface, so that methylene blue is almost completely removed at the beginning of the reaction, so that the slow reaction in the second step is difficult to explain, which could be due to reaction with the methylene blue absorbed into biochar matrix during initial contact.

TABLE 2
Removal velocity constants ( [symbol] ) and coefficients of determination (R²) of MB
under different treatment

| Treatments | Zone | Equation | [symbol] (hr⁻¹) |
|---|---|---|---|
| H₂O₂ | I | Y = −0.0830 × −0.0056 (R² = 0.9222) | 0.0830 |
| | II | Y = −0.0012 × −0.0315 (R² = 1.0000) | 0.0012 |
| Biochar | I | Y = −0.0203 × −0.0220 (R² = 0.8483) | 0.0203 |
| | II | Y = −0.0033 × −0.0831 (R² = 1.0000) | 0.0033 |
| H₂O₂/Biochar | I | Y = −0.0740 × −0.0495 (R² = 0.8887) | 0.0740 |
| | II | Y = −0.0083 × −0.2781 (R² = 0.9972) | 0.0083 |
| H₂O₂/Fe—BC | I | Y = −143.74 × (R² = 1.0000) | 143.70 |
| | II | Y = −0.0412 × −7.1816 (R² = 0.9148) | 0.0412 |

### 5.2.7. Comparison of Pure Iron, Iron Containing Activated Carbon, and Iron Containing Biochar.

The determination of the optimal [H₂O₂]/[Fe²⁺] molar ratio is important because it can directly affect the production of OH. radicals in Fenton reaction. However, the optimum molar ratio of [H₂O₂]/[Fe²⁺] for the treatment of various recalcitrant organic pollutants by Fenton oxidation reaction may not be consistent [46,55]. Various optimum molar ratios of [H₂O₂]/[Fe²⁺] have been reported for the removal of different target organic pollutants covering the range of 1:1 to 400:1 [56]. In this work, Fe—BC catalysts could not determine Fe²⁺ concentration due to Fe-impregnation into biochar. Therefore, we used molar ratio of [H₂O₂]/[Feₜₒₜₐₗ] to compare with pure Fe (homogeneous Fenton reaction) [48] and iron containing activated carbon, Fe-AC, (heterogeneous Fenton reaction) [57] for MB removal. Molar ratios of [H₂O₂]:[Feₜₒₜₐₗ] in pure-Fe, Fe-AC, Fe—BC were 12.3:1, 1.1:1, and 1.1:1, respectively, indicating that [H₂O₂]/[Feₜₒₜₐₗ] molar ratio of heterogeneous Fenton reaction with Fe-AC and Fe—BC was lower than that of homogeneous with Pure-Fe. This is because the Fe-impregnated catalysts contain large amount of Fe. However, FIG. 3 and FIG. 7B showed that content of iron released from Fe—BC during Fenton oxidation reaction was only a very low fraction, thus Fenton oxidation reaction by Fe—BC is essentially heterogeneous. On the other hand, as much as 24% of impregnated Fe could be released from Fe-AC according to the literature [36].

Molar ratios of pollutant to Fe in biochar expressed as [Poll]:[Feₜₒₜₐₗ] in pure-Fe, Fe-AC, Fe—BC were 1:1.15, 1:114, and 1:6.2, respectively, with that in pure-Fe was higher than that in Fe-AC and Fe—BC. The molar ratio of [Poll]:[H₂O₂] under different catalysts was in the following order: Fe—BC (1:7.0)>Pure Fe (1:14.1)>>Fe-AC (1:127). The amount of H₂O₂, dose for MB removal by Fe—BC was much smaller than that by pure Fe and Fe-AC. The [H₂O₂]:[Poll] of 7.0 ratio in heterogeneous Fenton with Fe—BC was much more cost-effective to achieve efficient removal of MB at low concentration of H₂O₂, which was much lower than that for homogeneous Fenton reaction with pure Fe and for heterogeneous Fenton reaction with Fe-AC.

Finally, based on all above considerations, the results suggest that the optimum ratios of [Poll]:[Feₜₒₜₐₗ]:[H₂O₂] in pure Fe, Fe-AC, and Fe—BC were 1:1.15:14.1, 1:114:127, 1:6.2:7.0, respectively. The Fe—BC has higher iron content than pure-Fe, but with magnetic properties, so it can be easily recovered from treated wastewater for reuse. The low hydrogen peroxide and Fe—BC dosage can reduce the operating cost. Mostly importantly, this newly developed Fe—BC has very high treatment efficiency for high MB concentrations.

TABLE 3
Comparison of optimal ratio on MB removal by pure Fe, Fe-AC, and Fe-BC

| | [Poll]:[Fe] | | [Poll]:[H₂O₂] | [H₂O₂]:[Fe] | [Poll]:[Fe]:[H₂O₂] | |
|---|---|---|---|---|---|---|
| | and | | and | and | and | |
| | Poll:Fe_{conc.} | Poll:Fe_{cat} | Poll:H₂O₂ | H₂O₂:Fe_{conc} | Poll:Fe_{cat}:H₂O₂ | |
| | (g/L) | (g/L) | (g/L) | (g/L) | (g/L) | References |
| Pure-Fe | 1:1.15 | | 1:14.1 | 12.3:1 | 1:1.15:14.1 | Dutta et al, |
| | and | | and | | | (2001) |
| | 0.01/0.002 | | 0.01:0.015 | | | |
| Fe-AC | 1:114 | 0.04/2 | 1:127 | 1.1:1 | 1:114:127 | Zhou et al. |
| | and | | and | and | and | (2014) |
| | 0.04:0.79 | | 0.04:0.54 | 0.54:0.79 | 1:50:13.5 | |
| Fe-BC | 1:6.23 | 0.1/0.5 | 1:7.0 | 1.1:1 | 1:6.23:7.0 | Experiments |
| | and | | and | and | and | of the |
| | 0.1:0.1 | | 0.1:0.075 | 0.075:0.1 | 1:5:0.75 | present |
| | | | | | | disclosure |

In addition, comparing to Fe-AC, Fenton oxidation by Fe—BC for MB removal in solution has at least the following advantages:
Fe—BC has the short reaction time for MB removal (3 minutes) compared with Fe-AC (1 hr).
Fe—BC can remove high concentrations of methylene blue in small amount of catalyst and H₂O₂, compared to Fe-AC
No or less pH adjustment of the dye wastewater is needed for effective oxidation over the wider pH range.
Fe—BC has the simplified Fe catalyst production process with energy reduction since Fe—BC is made by pretreatment of feedstock with FeSO₄ before pyrolysis (Feedstock with Fe source→pyrolysis→Fe—BC) as opposed to Fe-AC which is subjected to two pyrolysis (heat) treatment process (Feedstock→pyrolysis→activated carbon (AC)→AC with Fe source→Re-pyrolysis→Fe-AC).

The above experiments evaluated the catalytic activity, stability and reusability of the iron containing biochar disclosed herein in heterogeneous Fenton oxidation under different solution pHs, initial H₂O₂ concentrations, initial Fe—BC concentration, and initial methylene blue concentrations. The results show that catalyst composition disclosed herein exhibits superior catalyst capability for Fenton oxidation removal of recalcitrant organic pollutants such as industrial dye methylene blue (MB), especially at the low catalyst and hydrogen peroxide concentration, in comparison to conventional homogeneous and other heterogeneous Fenton catalysts. For example, the catalyst composition disclosed herein can effectively remove the pollutant over a wider pH range and still maintains strong stability and reusability.

Further, the results suggest that the most effective conditions of Fenton reaction for methylene blue removal were found as 0.075 g/L H₂O₂ and 0.5 g/L Fe—BC for 0.1 g/L methylene blue, at an initial pH of 4. Under these conditions, 99.9% removal efficiency of methylene blue was achieved within 3 minutes of reaction. The iron containing biochar showed high stability and reusability after four successive cycles of the Fenton oxidation and still maintained 95% methylene blue removal rate. The iron containing biochar also exhibited high removal of methylene blue at low concentration of H₂O₂ with [H₂O₂]:[MB] ratio of 7, which was much more cost-effective than that for homogeneous Fenton ([H₂O₂]:[MB] ratio of 14.1) with pure Fe and for heterogeneous Fenton ([H₂O₂]:[MB] ratio of 127) with Fe-AC. Overall, the above results demonstrated that the Fenton oxidation reaction by Fe—BC provides many advantages including the following. more economical, safe, efficient and recyclable than conventional homogeneous and other heterogeneous Fenton catalysts.

It should be recognized that unless stated otherwise, it is intended that endpoints are to be interchangeable. Further, any ranges include iterative ranges of like magnitude falling within the expressly stated ranges or limitations disclosed herein is to be understood to set forth every number and range encompassed within the broader range of values. It is to be noted that the terms “range” and “ranging” as used herein generally refer to a value within a specified range and encompasses all values within that entire specified range.

Except as may be expressly otherwise indicated, the article “a” or “an” if and as used herein is not intended to limit, and should not be construed as limiting, a claim to a single element to which the article refers. Rather, the article “a” or “an” if and as used herein is intended to cover one or more such elements, unless the text taken in context clearly indicates otherwise.

Each and every patent or other publication or published document referred to in any portion of this specification is incorporated as a whole into this disclosure by reference, as if fully set forth herein, for the purpose of describing and disclosing, for example, the constructs and methodologies that are described in the patents, publications, or published documents, which can be used in connection with the presently described subject matter. To the extent that any patent or other publication or published document incorporated herein by reference conflicts with the disclosure provided herein, the disclosure provided herein controls.

This present disclosure is susceptible to considerable variation in its practice. The particular illustrative examples which are described with particularity in this specification are not intended to limit the scope of the present disclosure. Rather, the examples are intended as concrete illustrations of various features and advantages of the present disclosure, and should not be construed as an exhaustive compilation of each and every possible permutation or combination of materials, components, configurations or steps one might contemplate, having the benefit of this disclosure. Similarly, in the interest of clarity, not all features of an actual implementation of an apparatus, system or related methods of use are described in this specification. It of course will be appreciated that in the development of such an actual implementation, numerous implementation-specific decisions must be made to achieve the developers' specific goals, such as compliance with system-related and economic-related constraints, which may vary from one implementation to another. Moreover, it will be appreciated that while such a development effort might be complex and time-consuming, it would nevertheless be a routine undertaking for those of ordinary skill in the art having the benefit of this disclosure. Therefore, the foregoing description is not intended to limit, and should not be construed as limiting, the present disclosure to the particular exemplifications presented hereinabove.

### 6. REFERENCES

[1] M. Bobu, A. Yediler, I. Siminiceanu, S. Schulte-Hostede, Degradation studies of ciprofloxacin on a pillared iron catalyst, Appl. Catal. B: Environ. 83 (2008) 15-23.
[2] C. Zhang, M. Zhou, G. Ren, X. Yu, L. Ma, J. Yang, F. Yu, Heterogeneous electro-Fenton using modified iron-carbon as catalyst for 2,4-dichlorophenol degradation: Influence factors, mechanism and degradation pathway, Water Res. 70 (2015) 414-424.
[3] A. M. F. M. Guedes, L. M. P. Madeira, R. A. R. Boaventura, C. A. V. Costa, Fenton oxidation of cork cooking wastewater-overall kinetic analysis, Water Res. 37 (2003) 3061-3069.
[4] P. K. Malik, S. K. Saha, Oxidation of direct dyes with hydrogen peroxide using ferrous ion as catalyst, Sep. Purif. Technol. 31 (2003) 241-250.
[5] M. S. Lucas, J. A. Peres, Decolorization of the azo dye reactive black 5 by Fenton and photo-Fenton oxidation, Dyes Pigments 71 (2006) 236-244.
[6] A. D. Bokare, W. Choi, Review of iron-free Fenton-like systems for activating H₂O₂ in advanced oxidation processes, J. Hazard. Mater. 275 (2014) 121-135.
[7] F. Martinez, G. Calleja, J. A. Melero, R. Molina, Iron species incorporated over different silica supports for the heterogeneous photo-Fenton oxidation of phenol, Appl. Catal. B: Environ. 70 (2007) 452-460.
[8] T. D. Nguyen, N. H. Phan, M. H. Do, K. T. Ngo, Magnetic FeMO₄ (M:Fe, Mn) activated carbons: Febrication, characterization and heterogeneous Fenton oxidation of methyl orange, J.

Hazard. Mater. 185 (2011) 653-661.
[9] M. Munoz, Z. M. de Pedro, J. A. Casas, J. J. Rodriguez, Preparation of magnetite-base catalysts and their application in heterogeneous Fenton oxidation—A review, Appl. Catal. B: Environ. 176-177 (2015) 249-265.
[10] G. Pliego, J. A. Zazo, S. Blasco, J. A. Casas, J. J. Rodriguez, Treatment of highly polluted hazardous industrial wastewaters by combined coagulation-adsorption and high-temperature Fenton oxidation, Ind. Eng. Chem. Res. 51 (2012) 2888-2896.
[11] C. S. Castro, M. C. Guerreiro, L. C. A. Oliveira, M. Gonçalves, A. S. Anastácio, M. Nazzarro, Iron oxide dispersed over activated carbon: Support influence on the oxidation of the model molecule methylene blue, Appl. Catal. A: Gen. 367 (2009) 53-58.
[12] H. H. Huang, M. C. Lu, J. N. Chen, Catalytic decomposition of hydrogen peroxide and 2-chlorophenol with iron oxides, Water Res. 35 (2001) 2291-2299.
[13] R. C. C. Costa, F. C. C. Moura, J. D. Ardisson, J. D. Fabri, R. M. Lago, Highly active heterogeneous Fenton-like systems based on Fe⁰/Fe₃O₄ composites prepared by controlled reduction of iron oxides, Appl. Catal. B: Environ. 83 (2008) 131-139.
[14] S. R. Pouran, A. A. A. Raman, W. M. A. W. Daud, Review on the application of modified iron oxides as heterogeneous catalysts in Fenton reactions, J. Clean. Prod. 64 (2014) 24-35.
[15] L Chen, C. H. Zhou, S. Fiore, D. S. Tong, H. Zhang, C. S. Li, S. F. Ji, W. H. Yu, Functional magnetic nanoparticle/clay mineral nanocomposites: preparation, magnetism and versatile application, Applied Clay Science 127-128 (2016) 143-163.
[16] L Bounab, O. Iglesias, M. Pazos, M. Á. Sanromin, E. Gonzalez-Romero, Effective monitoring of the electro-Fenton degradation of phenolic derivatives by differential pulse voltammetry on multi-walled-carbon nanotubes modified screen-printed carbon electrodes, Appl. Catal. B: Environ. 180 (2016) 544-550.
[17] Y. Yao, Y. Cai, F. Lu, F. Wei, X. Wang, S. Wang, Magnetic recoverable MnFe₂O₄ and MnFe₂O₄-graphene hybrid as heterogeneous catalysts of peroxymonosulfate activation for efficient degradation of aqueous organic pollutants, J. Hazard. Mater. 270 (2014) 61-70.
[18] J. C. Tristão, F. G. de Mendonça, R. M. Lago, J. D. Ardisson, Controlled formation of reactive Fe particles dispersed in a carbon matrix active for the oxidation of aqueous contaminants with H₂O₂, Environ. Sci. Pollut. Res. 22 (2015) 856-863.
[19] M. Ahmad, A. U. Rajapaksha, J. E. Lim, M. Zhang, N. Bolan, D. Mohan, M. Vithanage, S. S. Lee, Y. S. Ok, Biochar as a sorbent for contaminant management in soil and water. A review, Chemosphere 99 (2014) 19-23.
[20] G. Ding, B. Wang, L. Chen, S. Zhao, Simultaneous adsorption of methyl red and methyl blue onto biochar and an equilibrium modeling at high concentration, Chemosphere 163 (2016) 283-289.
[21] D. D. Sewn, P. Boakye, S. H. Woo, Highly efficient adsorption of cationic dye by biochar produced with Korean cabbage waste, Bioresour. Technol. 224 (2017) 206-213.
[22] L Leng, X. Yuan, H. Huang, J. Shao, H. Wang, X. Chen, G. Zeng, Bio-char derived from sewage sludge by liquefaction: Characterization and application for dye adsorption, Appl. Surf. Sci. 346 (2015) 223-231.
[23] L Lonappan, T. Rouissi, R. K. Das, S. K. Brar, A. A. Ramirez, M. Verma, R. Y. Surampalli, J. R. Valero, Adsorption of methylene blue on biochar microparticles derived from different waste materials, Waste Manage. 49 (2016) 537-544.
[24] F. Xiao, W. Li, L Fang, D. Wang, Synthesis of akageneit (beta-FeOOH)/reduced graphene oxide nanocomposites for oxidative decomposition of 2-chlorophenol by Fenton-like reaction, J. Hazard. Mater. 308 (2016) 11-20.
[25] H. Lyu, Y. Gong, J. Tang, Y. Huang, Q. Wang, Immobilization of heavy metals in electroplating sludge by biochar and iron sulfide, Environ. Sci. Pollut. Res. 23 (2016) 14472-14488.
[26] H. Wu, G. Gap, X. Zhou, Y. Zhang, S. Guo, Control on the formation of Fe₃O₄ nanoparticles on chemically reduced graphene oxide surface. Cryst Eng Comm. 14 (2012) 499-504.
[27] J. Tang, Y. Huang, Y. Gong, H. Lyu, Q. Wang, J. Ma, Preparation of a novel graphene oxide/Fe—Mn composite and its application for aqueous Hg(II) removal. J. Hazard. Mater. 316 (2016) 151-158.
[28] N. Xu, W. Li, M. Zhang, X. Wang, Reinforcing effect of Lewis id-base interaction on the high-temperature colloidal stability and tribological performance of lubricating grease. J. Ind. Eng. Chem. 46 (2017) 157-164.
[29] A. D. Roberts, X. Li, H. Zhang, Hierarchically porous sulfur-containing activated carbon monoliths via ice-templating and one-step pyrolysis. Carbon 95 (2015) 268-278.
[30] Y. L Pang, S. Bhatia, A. Z. Abdullah, Process behavior of TiO₂ nanotube-enhanced sonocatalytic degradation of Rhodamine B in aqueous solution, Sep. Purif. Technol, 77 (2011) 331-338.
[31] J. K. Im, J. Yoon, N. Her, J. Han, K. D. Zoh, Y. Yoon, Sonocatalytic-Tio nanotube, Fenton, and CCl₄ reactions for enhanced oxidation, and their application to acetaminophen and naproxen degradation, Sep. Purif. Technol. 141 (2015) 1-9.
[32] J. Feng, X. Hu, P. L Yue, Effect of initial solution pH on the degradation of Orange II using clay-based Fe nanocomposites as heterogeneous photo-Fenton catalyst, Water Res. 40 (2006) 641-646.
[33] J. Herney-Ramirez, M. A. Vicente, L. M. Madeira, Heterogeneous photo-Fenton oxidation with pillared clay-based catalysts for wastewater treatment: A review, Appl. Catal. B: Environ. 98 (2010) 10-26.
[34] W. N. Najjar, S. Azabou, S. Sayadi, A. Ghorbel, Catalytic wet peroxide photo-oxidation of phenolic olive oil mill wastewater contaminants: Part I. Reactivity of tyrosol over (Al—Fe)PILC, Appl. Catal. B: Environ. 74 (2007) 11-18.
[35] L Xu, J. Wang, A heterogeneous Fenton-like system with nanoparticulate zero-valent iron for removal of 4-chloro-3-methyl phenol, J. Hazard. Mater. 186 (2011) 256-264.
[36] S. Navalon, A. Dhakshinamoorthy, M. Alvaro, H. Garcia, Heterogeneous Fenton catalysts based on activated carbon and related materials, Chem. Sus. Chem. 12 (2011) 1712-1730.
[37] M. N. Timofeeva, S. Ts. Khankhasaeva, S. V. Badmaeva, A. L. Chuvllin, E. B. Burgina, A. B. Ayupov, V. N. Panchenko, A. V. Kulikova, Synthesis, characterization and catalytic application for wet oxidation of phenol of iron-containing clays, Appl. Catal. B: Environ. 59 (2005) 243-248.
[38] A. Houas, H. Lachheb, M. Ksibi, E. Elaloui, C. Guillard, J. M. Hermann, Photocatalytic degradation pathway of methylene blue in water, Appl. Catal. B: Environ. 31 (2001) 145-157.
[39] I. A. Katsoyiannis, T. Ruettimann, S. J. Hug, pH dependence of Fenton reagent generation and As(III) oxidation and removal by corrosion of zero valent iron in aerated water, Environ. Sci. Technol. 42 (2008) 7424-7430.
[40] R. Su, J. Sun, Y. P. Sun, K. J. Deng, D. M. Cha, D. Y. Wang, Oxidative degradation of dye pollutants over a broad pH range using hydrogen peroxide catalyzed by FePz(dtnCl₂)₄, Chemosphere 77 (2009) 1146-1151.
[41] C. Lee, C. R. Keenan, D. L Sedlak, Polyoxometalate-enhanced oxidation of organic compounds by nanoparticulate zero-valent iron and ferrous ion in the presence of oxygen, Environ. Sci. Technol. 42 (2008) 4921-4926.
[42] C. R. Keenan, D. L Sedlak, Factors affecting the yield of oxidants from the reaction of nanoparticulate zero-valent iron and oxygen, Environ. Sci. Technol. 42 (2008) 1262-1267.
[43] N. K. Daud, B. H. Hameed, Decolorization of acid red 1 by Fenton-like process using rice husk ash-based catalyst, J. Hazard. Mater. 176 (2010) 938-944.
[44] N. Masomboon, C. Ratanatamskul, M. C. Lu, Chemical oxidation of 2,6-dimethylaniline in the Fenton process, Environ. Sci. Technol. 43 (2009) 8629-8634.
[45] P. L Huston, J. J. Pignatello, Degradation of selected pesticide active ingredients and commercial formulations in water by the photo-assisted Fenton reaction. Water Res. 33 (1999) 1238-1246.
[46] K. Dutta, S. Mukhopadhyay, S. Bhattacharjee, B. Chaudhuri, Chemical oxidation of methylene blue using a Feton-like reaction, J. Hazard. Mater. B84 (2001) 57-71.
[47] S. Yang, H. He, D. Wu, D. Chen, X. Liang, Z. Qin, M. Fan, J. Zhu, P. Yuan, Decolorization of methylene blue by heterogeneous Fenton reaction using Fe₃₋ₓTiₓO₄ (0≤x≤0.75) at neutral pH values, Appl. Catal. B: Environ. 89 (2009) 527-535.
[48] F. Huang, L Chen, H. Wang, Z. Yan, Analysis of the degradation mechanism of methylene blue by atmospheric pressure dielectric barrier plasma, Chem. Eng. J. 162 (2010) 250-256.
[49] M. Tekbas, H. C. Yatmaz, N. Bektas, Heterogeneous photo-Fenton oxidation of reactive azo dye solutions using iron exchanged zeolite as a catalyst, Microporous Mesoporous Mater. 115 (2008) 594-602.
[50] H. Hassan, B. H. Hameed, Fe-clay as effective heterogeneous Fenton catalyst for the decolorization of Reactive Blue 4, Chem. Eng. J. 171 (2011) 912-918.
[51] J. Deng, J. Jiang, Y. Zhang, X. Lin, C. Du, Y. Xiong, FeVO₄ as a highly active heterogeneous Fenton-like catalyst towards the degradation of Orange II, Appl. Catal. B: Environ. 84 (2008) 468-473.
[52] S. Esplugas, J. Giménez, S. Contreras, E. Pascual, M. Rodríquez, Comparison of different advanced oxidation processes for phenol degradation, Water Res. 36 (2002) 1034-1042.
[53] D. C. Seo, J. S. Cho, H. J. Lee, J. S. Heo, Phosphorus retention capacity of filter media for estimating the longevity of constructed wetland, Water Res. 39 (2005) 2445-2457.
[54] S. F. Kang, C. H. Liao, M. C. Chen, Pre-oxidation and coagulation of textile wastewater by the Fenton process, Chemosphere 46 (2002) 923-928.
[55] G. Hodaifa, J. M. Ochando-Pulido, S. Rodriquez-Vives, A. Martinez-Ferez, Optimization of continuous reactor at pilot scale for olive-oil mill wastewater treatment by Fenton-like process, Chem. Eng. J. 220 (2013) 117-124.
[56] J. R. Guimarães, M. G. Maniero, R. N. de Araújo, A comparative study on the degradation of RB-19 dye in an aqueous medium by advanced oxidation processes, J. Environ. Manage. 110 (2012) 33-39.
[57] L Zhou, Y. Shao, J. Liu, Z. Ye, H. Zhang, J. Ma, Y. Jia, W. Gao, Y. Li, Preparation and characterization of magnetic porous carbon microspheres for removal of methylene blue by a heterogeneous Fenton reaction, Appl. Mater. Interfaces 6 (2014) 7275-7285.

What is claimed is:

1. A method comprising:
impregnating a biomass with a pretreatment solution comprising an iron containing compound to form a pretreated biomass;
dehydrating the pretreated biomass; and
pyrolyzing the pretreated biomass under conditions sufficient to form a biochar;
wherein the biochar comprises:
(A) iron present in an amount in the range of about 0.10 wt. % to about 30 wt. %, based on total weight of the biochar; and
wherein the biochar has a pH in the range of from about 2 to about 7.

2. The method of claim 1 wherein the biochar has iron present in an amount in the range of about 8 wt. % to about 20 wt. %, based on total weight of the biochar; and the pH of the biochar is in the range of about 3 and about 5.

3. The method of claim 1 wherein the pretreatment solution comprises at least one ferrous salt.

4. The method of claim 1 wherein the biomass is impregnated with the pretreatment solution by contacting the biomass with pretreatment solution or mixing the biomass with the pretreatment solution.

5. The method of claim 4 wherein the at least one ferrous salt is selected from the group consisting of ferrous sulfate, ferrous chloride, ferrous nitrate, and any combination of two or more of the foregoing.

6. The method of claim 1 wherein the pretreatment solution to biomass ratio is from about 2 to about 20, on a weight basis.

7. The method of claim 1 wherein the pyrolyzing step is carried out at a temperature in the range of about 400° C. to about 700° C.

8. The method of claim 1 wherein the dehydrating step is carried out at a temperature in the range of about 60° C. to about 120° C.

9. The method of claim 1 wherein the biomass comprises one or more materials selected from the group consisting of sugarcane residue, rice straw, rice husk, miscanthus, switch grass, wood chips, and any combination of two or more of the foregoing.

10. The method of claim 1 wherein the biochar has an ash content present in an amount in the range of about 10 wt. % to about 50 wt. %, based on total weight of the biochar.

11. A catalyst composition comprising a biochar, wherein the biochar comprises:
(A) iron present in an amount in the range of about 0.10 wt. % to about 30 wt. %, based on total weight of the biochar; and
wherein the biochar has a pH in the range of from about 2 to about 7.

12. The catalyst composition of claim 11 wherein the iron is impregnated in the biochar in the form of Fe₃O₄, Fe₂O₃, FeOOH and any combination of two or more of the foregoing.

13. The catalyst composition of claim 11, wherein the biochar further comprises a component selected from the group consisting of sulfur, chlorine, nitrogen, and any combination of two or more of the foregoing, wherein the component is present in an amount in the range of 0.02 wt. % to about 10 wt. %, based on total weight of the biochar.

14. The catalyst composition of claim 11 wherein the biochar has a surface area in the range of about 170 to about 230 m²/g.

15. The catalyst composition of claim 11 wherein the biochar has a total pore volume in the range of about 0.1 to about 0.2 cm³/g.

16. The catalyst composition of claim 11 wherein the biochar has an ash content present in an amount in the range of about 10 wt. % to about 50 wt. %, based on total weight of the biochar.

17. A method comprising:
(A) contacting a waste source comprising a pollutant with the catalyst composition according to claim 11 and hydrogen peroxide to form a reaction mixture;
(B) oxidizing at least a portion of the pollutant under conditions sufficient to form an oxidized pollutant or intermediate compound; and
(C) separating the oxidized pollutant or intermediate compound from the reaction mixture.

18. The method of claim 17 wherein the reaction mixture has a concentration of the pollutant in the range of from about 0.1 to about 0.5 g/L.

19. The method of claim 17 wherein the reaction mixture has a pH in the range of about 3 to about 9.

20. The method of claim 17 wherein the reaction mixture has a concentration of hydrogen peroxide in the range of from about 0.015 to about 0.9 g/L.

21. The method of claim 17 wherein the reaction mixture has a concentration of the biochar in the range of from about 0.1 to about 1.0 g/L.

22. The method of claim 17 wherein the pollutant comprises at least one selected from the group consisting of one or more dyes, one or more antibiotics, one or more polycyclic aromatic hydrocarbons, one or more pesticides, one or more halogens, one or more chemical oxygen demand (COD) compounds, and any combination of two or more of the foregoing.

23. The method of claim 17 wherein the pollutant comprises one or more dyes selected from the group consisting of methylene blue, orange gelb, and any combination of two or more of the foregoing.

24. The method of claim 17 wherein the separating step comprises removing the oxidized pollutant from the waste water by a separation process selected from the group consisting of magnetic separation, centrifuge, filtration, and any combination of two or more of the foregoing.
